(19) United States
(12) Patent Application Publication
(10) Pub. No.: US 2022/0012570 A1
(43) Pub. Date: Jan. 13, 2022

(54) BAYESIAN COMPUTE UNIT WITH RECONFIGURABLE SAMPLER AND METHODS AND APPARATUS TO OPERATE THE SAME

(71) Applicants: Srivatsa Rs, Hillsboro, OR (US); Indranil Chakraborty, Mountain View, CA (US); Ranganath Krishnan, Hillsboro, OR (US); Uday A Korat, Folsom, CA (US); Muluken Hailesellasie, San Jose, CA (US); Jainaveen Sundaram Priya, Hillsboro, OR (US); Deepak Dasalukunte, Beaverton, OR (US); Dileep Kurian, Bangalore (IN); Tanay Karnik, Portland, OR (US)

(72) Inventors: Srivatsa Rs, Hillsboro, OR (US); Indranil Chakraborty, Mountain View, CA (US); Ranganath Krishnan, Hillsboro, OR (US); Uday A Korat, Folsom, CA (US); Muluken Hailesellasie, San Jose, CA (US); Jainaveen Sundaram Priya, Hillsboro, OR (US); Deepak Dasalukunte, Beaverton, OR (US); Dileep Kurian, Bangalore (IN); Tanay Karnik, Portland, OR (US)

(21) Appl. No.: 17/483,382

(22) Filed: Sep. 23, 2021

(30) Foreign Application Priority Data
Jun. 4, 2021 (IN) 202141024844

(51) Int. Cl. G06N 3/04; G06N 3/063; G06F 7/58; G06F 9/30

(52) U.S. Cl. CPC G06N 3/0472; G06F 9/30134; G06F 7/582; G06N 3/063

(57) ABSTRACT

Methods, apparatus, systems, and articles of manufacture providing a Bayesian compute unit with reconfigurable sampler and methods and apparatus to operate the same are disclosed. An example apparatus includes a processor element to generate (a) a first element by applying a mean value to an activation and (b) a second element by applying a variance value to a square of the activation, the mean value and the variance value corresponding to a single probability distribution; a programmable sampling unit to: generate a pseudo random number; and generate an output based on the pseudo random number, the first element, and the second element, wherein the output corresponds to the single probability distribution; and output memory to store the output.

### RELATED APPLICATION

This patent arises from Indian Provisional Patent Application Number 202141024844 which was filed on Jun. 4, 2021. Indian Provisional Patent Application Number 202141024844 is hereby incorporated herein by reference in its entirety. Priority to Indian Provisional Patent Application Number 202141024844 is hereby claimed.

### FIELD OF THE DISCLOSURE

This disclosure relates generally to machine learning, and, more particularly, to a Bayesian compute unit with reconfigurable sampler and methods and apparatus to operate the same.

### BACKGROUND

In recent years, artificial intelligence (e.g., machine learning, deep learning, etc.) have increased in popularity. Artificial intelligence may be implemented using neural networks. Neural networks are computing systems inspired by the neural networks of human brains. A neural network can receive an input and generate an output. The neural network includes a plurality of neurons corresponding to weights can be trained (e.g., can learn, be weighted, etc.) based on feedback so that the output corresponds a desired result. Once the weights are trained, the neural network can make decisions to generate an output based on any input. Neural networks are used for the emerging fields of artificial intelligence and/or machine learning. A Bayesian neural network is a particular type of neural network that includes neurons that generate a variable weight as opposed to a fixed weight. The variable weight falls within a probability distribution defined by a mean value and a variance determined during training of the Bayesian neural network.

### BRIEF DESCRIPTION OF THE DRAWINGS

FIG. 1 is a schematic illustration of an example Bayesian neural network.

FIG. 2A and 2B are block diagrams of example implementations of a layer of the Bayesian neural network of FIG. 1.

FIG. 3 illustrates an example of the data processing flow of example processing elements of the layers of FIGS. 2A and/or 2B.

FIG. 4A is a block diagram of an example implementation of the programmable sampling unit of the layer of FIGS. 2A and/or 2B.

FIG. 4B is a circuit diagram of an example implementation of the programmable sampling unit of the layer of FIGS. 2A and/or 2B.

FIGS. 5-6 illustrate a flowchart representative of example machine readable instructions which may be executed to implement the example Bayesian compute node and/or the programmable sampling unit of FIGS. 2A, 2B, 3, and/or 4.

FIG. 7 is a block diagram of an example processing platform structured to execute the instructions of FIGS. 5-6 to implement the example Bayesian compute node and/or programmable sampling unit of FIGS. 2A, 2B, 3, and/or 4.

FIG. 8 is a block diagram of an example implementation of the processor circuitry of FIG. 7.

FIG. 9 is a block diagram of another example implementation of the processor circuitry of FIG. 7.

FIG. 10 is a block diagram of an example software distribution platform to distribute software (e.g., software corresponding to the example computer readable instructions of FIGS. 5-6 to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. In general, the same reference numbers will be used throughout the drawing(s) and accompanying written description to refer to the same or like parts. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Although the figures show layers and regions with clean lines and boundaries, some or all of these lines and/or boundaries may be idealized. In reality, the boundaries and/or lines may be unobservable, blended, and/or irregular.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Machine learning models, such as neural networks, are used to perform a task (e.g., classify data). Machine learning can include a training stage to train the model using ground truth data (e.g., data correctly labelled with a particular classification). Training a traditional neural network adjusts the weights of neurons of the neural network. After trained, data is input into the trained neural network and the weights of the neurons are applied to input data to be able to process the input data to perform a function (e.g., classify data).

Overfitting and/or sensitivity to malicious attacks negatively affect the performance and/or reliability of traditional neural networks. Overfitting occurs when a model is trained to have too small of an error. If the training results in too small of an error, the model has a difficult time generalizing for new situations. Malicious attacks can exploit a combination of overfitting and/or knowledge of the underlying neural network model. Sensitivity to malicious attacks is the result of a trained model being overconfident in its outputs. If a model is overconfident, small perturbations to the inputs can result in undesired and/or unpredictable changes in the output. Both of the above problems are caused by the failure of traditional neural networks to include uncertainty information in a finite set of training data.

Bayesian neural networks (BNNs) and/or Bayesian Deep Neural Networks (BDNN) introduce uncertainty information to overcome the problems of overfitting and sensitivity to malicious attacks. Instead of using fixed weights, BDNNs introduce weights associated with conditioned probability distribution (e.g., the output weight may be a value within a probability distribution defined by a mean (herein also referred to as mu or u) and standard deviation and/or variance (generally referred to as σ²)). Because BDNNs introduce some amount of randomness, BDNNs can be trained with smaller training data without sacrificing accuracy. However, traditional BDNNs with neurons that generate weights corresponding to a probability distribution require a lot of power and/or hardware to implement. Therefore, such traditional BDNNs are slow due to bottlenecks caused by the sampling of a probability distribution and/or the multiple iterations of forward passes of a BDNN with different weight value(s) sampled from the distribution. For example, traditional BDNN generate a single weight per probability distribution which requires a lot of overhead to generate and/or store multiple weights because the traditional systems access the mean and variance from system memory for every weight generated.

The computations in a BDNN layer for multiple forwarded passes can be represented using the below Equation 1.

Oₙⱼ=ΣᵢIₙᵢWₙᵢⱼ=ΣᵢIₙᵢN(μᵢⱼ, ρᵢⱼ²) (Equation 1)

In Equation 1, O is the output, I is the input, W is the weight n is the index of the forward pass, i and j are indices of the weight element in a filter, μ is the mean, and σ² is the variance. The below Equation 2 is a reparameterization of Equation 1.

Oₙⱼ=ΣᵢIₙᵢWₙᵢⱼ=N(ΣᵢIₙᵢμᵢⱼ, ΣᵢIₙᵢσij²)=N(βₙⱼ, δₙⱼ²) (Equation 2)

Based on Equation 2, examples disclosed herein can sample the j^{th} output element of n^{th} forward pass from the distribution with mean and variance δ². Through this mathematical re-organization, the number of samples that need to be generated is reduced from number of weights in dimension i and j, to number of outputs in dimension j. For a convolutional layer with configuration k×k×I×O, total number of weights are k²I O and number of outputs are H×W×O where k×k is the kernel size, I is input channels, O is output channels, H and W are height and width of output image. For a fully connected layer, number of weights are I×0 and number pf outputs are O. Thus, examples disclosed herein leverage the mathematical re-organization of Equation 2 to reduce sampling overhead.

Examples disclosed herein leverage the advantage of the above Equation 2 to provide an efficient BDNN using a sampling unit that supports both Gaussian distribution models and Gaussian mixture model (GMM) distribution models to leverage input re-use for BDNN workloads. As used herein, a unit may include hardware (e.g., a circuit, a processor, etc.), software, firmware, and/or any combination thereof. Examples disclosed herein take input data and apply a mean and variance to generate a mean-based result (e.g., a product of the mean and the input) and a variance-based result (e.g., the product of the variance and the input). The results are provided to a programmable sampling unit. The programmable sampling unit can be configured to output multiple samples from a parameterized Gaussian distribution as well as GMM models based on the mean-based result and the variance-based result. In this manner, the mean and variance value(s) corresponding to the signal probability distribution and the input data are accessed once and multiple different outputs can be generated and used based on the single distribution, thereby allowing low sampling overhead. Accordingly, examples disclosed herein result in a more efficient artificial intelligence-based compute unit that reduces the amount of data movement to generate and apply weights corresponding to a probability distribution.

The computations of examples disclosed herein may be unique because the activations corresponding to different forward passes are typically unique. To obtain throughput improvements, examples disclosed herein re-use computations through input reuse (IR). Accordingly, examples disclosed herein leverage the below Equation 3. Equation 3 is a mathematical repurposing of Bayesian computations to leverage IR. This mathematical formulation considers the same input across different forward passes:

Oₙⱼ=ΣᵢIᵢWₙᵢⱼ=ΣᵢIᵢN(μᵢⱼ, σᵢⱼ²)=N(ΣᵢIᵢμᵢⱼ, ΣᵢIᵢ²σᵢⱼ²)=N(βⱼ, δⱼ²) (Equation 3)

Through this mathematical reparameterization, examples disclosed herein obtain a single output distribution parameter for each activation (e.g., pixel) corresponding to multiple forward passes. By sampling multiple output samples from this distribution, examples disclosed herein perform Bayesian computations with lower number of total computations.

In general, implementing a machine learning (ML)/artificial intelligence (AI) system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters may be used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, training is performed until a threshold number of actions have been predicted. In examples disclosed herein, training is performed either locally (e.g., in the device) or remotely (e.g., in the cloud and/or at a server). Training may be performed using hyperparameters that control how the learning is performed (e.g., a learning rate, a number of layers to be used in the machine learning model, etc.). In some examples re-training may be performed. Such re-training may be performed in response to a new program being implemented or a new user using the device. Training is performed using training data. When supervised training may be used, the training data is labeled. In some examples, the training data is pre-processed.

Once training is complete, the model is deployed for use as an executable construct that processes an input and provides an output based on the network of nodes and connections defined in the model. The model is stored locally in memory (e.g., cache and moved into memory after trained) or may be stored in the cloud. The model may then be executed by the computer cores.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

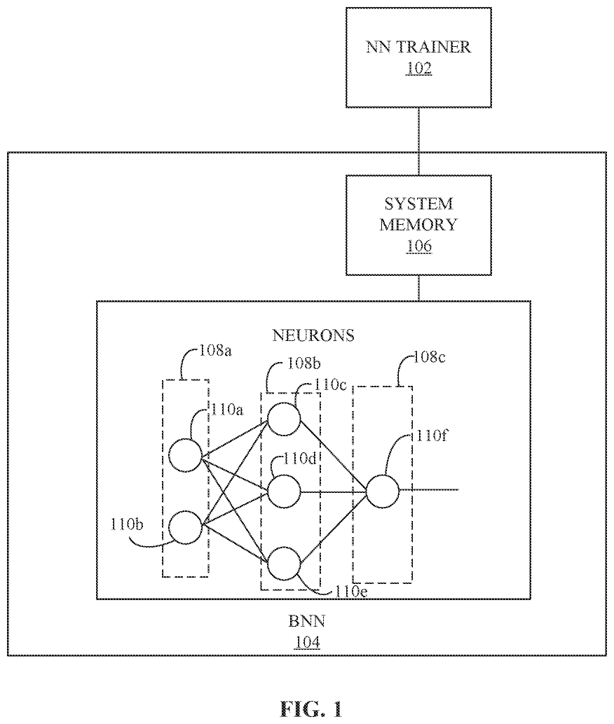

FIG. 1 is a schematic illustration of an example neural network (NN) trainer 102 to train an example BDNN 104. The example BDNN 104 includes an example system memory 106 and example layers 108a-c including example neurons 110a-f (herein referred to as neurons or compute nodes). Although the illustrated neurons 110 of FIG. 1 include six neurons in three layers, there may be any number of neurons in any type of configuration. Although the example of FIG. 1 is described in conjunction with the BDNN 104, examples disclosed herein may be utilized in any AI-based system or model that includes weights. Although FIG. 1 includes the BDNN 104, examples disclosed herein can be utilized in a BNN and/or any other probability distribution-based AI model.

The example NN trainer 102 of FIG. 1 trains the BDNN 104 by selecting a mean weight and an amount of deviation for the mean weight for each of the neurons 110. Initially, the BDNN 104 is untrained (e.g., the neurons are not yet weighted with a mean and deviation). To train the BDNN 104, the example NN trainer 102 of FIG. 1 uses training data (e.g., input data labeled with known classifications and/or outputs) to configure the BDNN 104 to be able to predict output classifications for input data with unknown classifications. The NN trainer 102 may train a model with a first set of training data and test the model with a second set of the training data. If, based on the results of the testing, the accuracy of the model is below a threshold, the NN trainer 102 can tune (e.g., adjust, further train, etc.) the parameters of the model using additional sets of the training data and continue testing until the accuracy is above the threshold. After the NN trainer 102 has trained the BDNN 104, the example NN trainer 102 stores the corresponding means and deviations for the respective neurons 110 in the example system memory 106 of the example BDNN 104. The example NN trainer 102 may be implemented in the same device as the BDNN 104 and/or in a separate device in communication with the example BDNN 104. For example, the NN trainer 102 may be located remotely, develop the weight data locally, and deploy the distribution data (e.g., means and variance for the respective neurons 110) to the BDNN 104 for implementation (e.g., generation of weights that correspond to the determine distribution data).

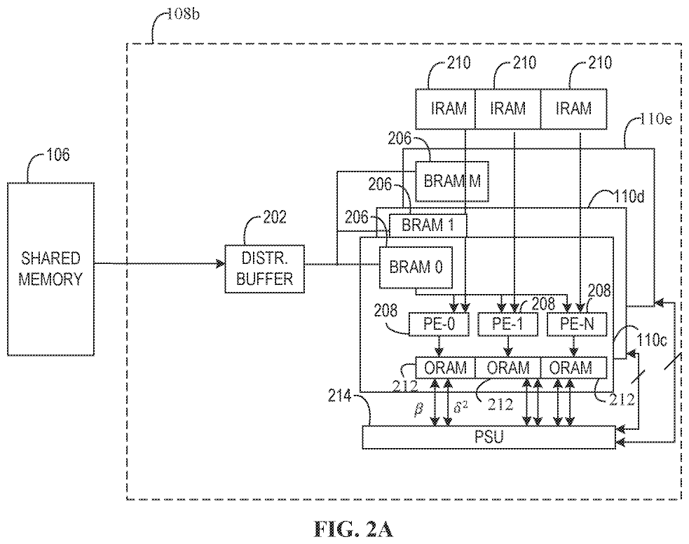

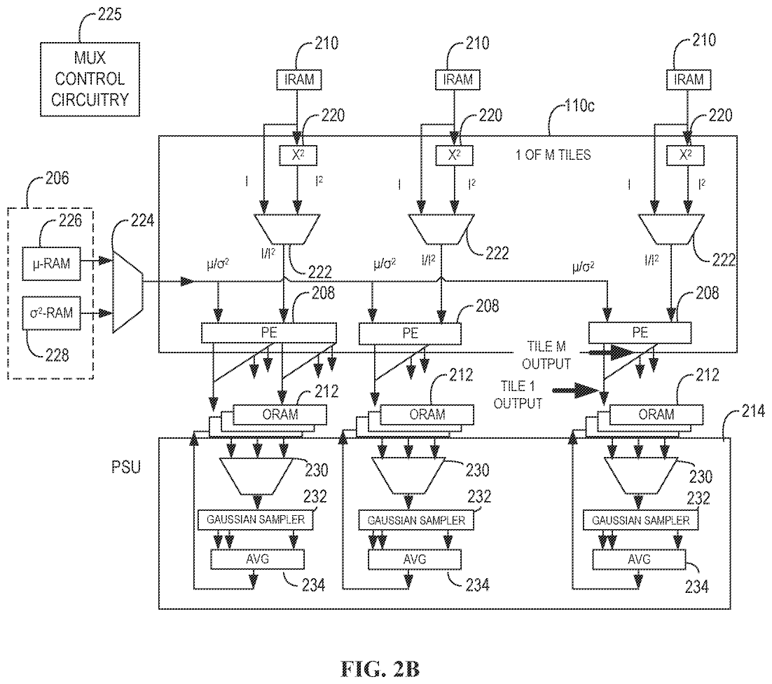

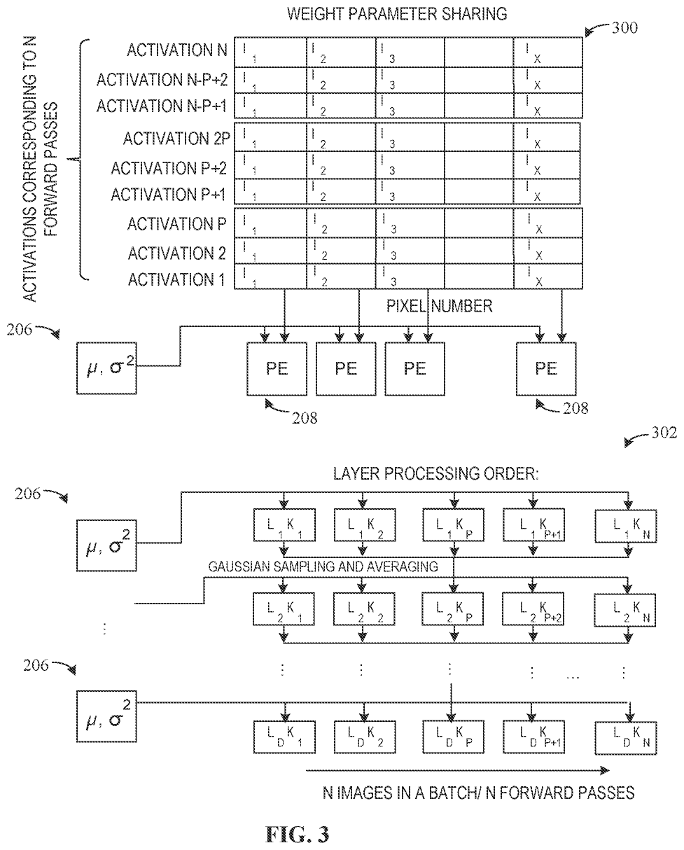

The example BDNN 104 of FIG. 1 includes the example system memory 106. The example system memory 106 stores the probability distribution data for the example NN trainer 102 in conjunction with a particular neuron (e.g., a mean and/or variance corresponding to a probability distribution for one or more compute nodes/neurons). For example, a first section of the system memory 106 is dedicated for a first mean value(s) and a first variance value(s) for a first neuron or a first layer of neurons, a second section of the system memory 106 is dedicated to a second mean value(s) and a second variance value(s) for a second neuron or a second layer of neurons, etc. The mean value(s) may be stored in the dedicated section as a bit value(s) representative of the mean value(s). As further described below, the programmable sampling unit of FIGS. 2A, 2B, 3, and/or 4 generate random numbers and/or pseudo random numbers that are used in conjunction with the mean-based results (e.g., a mean applied to input data) and variance-based results (e.g., variance applied to input data) to generate a plurality of outputs (e.g., based on an input) that correspond to a single probability distribution (e.g., Gaussian distribution) or the single mixture model (e.g., GMM) samples that correspond to a mixture probability distribution (e.g., with two or more means and/or two or more variances).

The example neurons 110a-f of FIG. 1 are structured in the example layers 108a-c. As further described below, the neurons 110a-f are implemented by compute nodes including, or in communication with, one or more programmable sampling units. The example neurons 110a-f receive input/activation data, apply weights and/or variance to the input/activation data to generate mean-based results and variance-based results, and apply the mean-based results and/or variance-based results to random/pseudo random numbers to generate one or more outputs that corresponds to a probability distribution or mixture probability distribution to generate an output. For example, if the probability distribution of a neuron follows a standard normal distribution, the mean weight of the neuron is 0.7, and the variance of the neuron is 0.01 (e.g., the standard deviation is 0.1), then the will be a 68% chance that the output will correspond to the input applied to a weight between 0.6 and 0.8 (e.g., one standard deviation away from the mean), a 95% chance that output will correspond to the input applied to a weight between 0.5 and 0.9 (e.g., two standard deviations away from the mean), etc. Accordingly, the output may be different for the same mean, variance, and input value, but the output will follow the probability distribution. Thus, the example neurons 110a-f provide randomness that can counteract overfitting and sensitivity to malicious attacks. The structure of the example layer 108b including example neurons 110c-e is further described below in conjunction with FIGS. 2A and 2B.

FIG. 2A is a block diagram of the example layer 108b include the example neurons (as referred to as tiles, compute units, nodes, or Bayesian compute units) 110c-e of FIG. 1. However, FIG. 2A could be described in conjunction with any of the example layers 108a-c and/or any of the neurons 110a-f. The example of FIG. 2A includes the example system memory 106 of FIG. 1. The example of FIG. 2A further includes an example distribution buffer 202, example distribution memory 206, example processing elements (PEs) 208, example input memory 210, and an example output memory 212, and an example programmable sampling unit (PSU) (also referred to as a programmable sampling circuit) 214. The example input memory 210 (IRAM) stores input and/or features, the distribution memory 206 (BRAM) stores weights (mean values and/or variance values) of the hidden layer, and the example output memory 212 (ORAM) stores the output features and/or partials. Although the example of FIG. 2A includes three processing elements implemented in three respective tiles to obtain data from three storage elements and output data into three storage elements, there may be any number of storage elements, processing elements, and such storage elements and/or processing elements may be arranged into any number of tiles.

The example distribution buffer 202 of FIG. 2 stores the mean and/or variance values stored in system memory 106 for each node 110 based on the trained data from the NN trainer 102. The weight buffer may be any type of memory or storage unit. The mean and variance correspond to a probability distribution that has been generated by the NN trainer 102. After storage of the mean and/or variance values in the system memory 106, the example distribution buffer 202 outputs the mean and variance values to the example distribution memory 206 (e.g., BRAM 0-BRAM M) of the individual compute units 110c-e (e.g., tile 0-tile M).

The example distribution memory 206 of FIG. 2 stores the mean and variance values locally at the corresponding compute nodes 110c-e (e.g., a first mean and variance for the first tile, a second mean and variance for the second tile, etc.). In this manner, the example PE 208 of a corresponding compute node 110c-e can access the mean and/or variance values to apply to input data and/or activation data, as further described below in conjunction with FIG. 3. In the example of FIG. 2A, the distribution memory 206 is random access memory (RAM). However, the example distribution memory 206 may be implemented by any type of storage.

The example PEs 208 of FIG. 2A apply the mean and/or variance values stored in the distribution memory 206 to the input data and/or activation data stored in the example input memory 210. In the example of FIG. 2A, the input memory 210 is random access memory (RAM). However, the example input memory 210 may be implemented by any type of storage. The PEs 208 of FIG. 2 apply mean and/or variance values corresponding to a single probability distribution to the corresponding input and/or activation data to generate output data (e.g., mean-based data (the product of the mean and the input data, referred herein as β) and/or variance-based data (the produce of the variance and the input data, referred to herein as δ²)). The example PEs 208 store the output data in the example output memory 212. The operation of the PEs 208 is further described below in conjunction with FIG. 3.

The example output memory 212 of FIG. 2 stores the output of the PEs 208. In the example of FIG. 2A, the output memory 212 is random access memory (RAM). However, the example output memory 212 may be implemented by any type of storage. The output data in the output memory 212 may be output to a compute node in a subsequent layer 108c, to a different one of the compute nodes 110c-e within the same layer 108b (e.g., for another pass in a different compute node), or put back into the input memory 210 (e.g., for another pass in the same compute node).

The example PSU 214 of FIG. 2 obtains mean-based value(s) and variance-based value(s) corresponding to a single probability distribution from the example ORAM 212. The example PSU 214 generates an output based on the mean-based value, the variance-based value, and a random/pseudo-random number generated by a random number generator. In some examples, the PSU 214 generates multiple outputs based on the mean-based value, the variance-based value, and a plurality of random/pseudo-random numbers (e.g., to correspond to multiple forward passes). In such examples, the PSU 214 may average the multiple output values to generate a single output value for the node 110d. Because the mean value(s) and variance value(s) correspond to a single probability distribution, the PSU 214 outputs the output value(s) that correspond to the probability distribution corresponding to the mean and variance generated during training. Each layer 108a-c may correspond to the same or different probability distributions. In some examples, the output data may correspond to a mixture probability distribution (e.g., a distribution with two or more modes). In such examples, the system memory 106 may include two or more mean value(s) and/or variance value(s) for the mixture probability distribution and the PSU 214 generates GMM-based outputs corresponding to the mixture model probability distribution. The example PSU 214 generates outputs that correspond to the probability distribution based on the mean value(s) and/or variance value(s). For example, if the mean is 0.7 and the variance is 0.1, the PSU 214 may generate N outputs (e.g., 40 outputs) for a single input that corresponds to the probability distribution that is based on a mean of 0.7 and a variance of 0.1. The PSU 214 may average the N outputs to generate a final output based on a single probability distribution. In this manner, different input data in a batch or different forwarded processing passes can be performed in parallel (e.g., simultaneously) using the different mean and/or variance value(s) without requiring updated mean and variance numbers, thereby reducing the resources (e.g., processing resources, bandwidth, clock cycles, etc.) needed to transmit updated mean and variance values from the system memory 106 to the PSU 214. In some examples, multiple forward passes are performed independently for each forward pass. The example PSU 214 is further described below in conjunction with FIG. 2B.

FIG. 2B is an additional and/or alternative block diagram of the example layer 108b include the example neurons (as referred to as tiles, compute units, or Bayesian compute units) 110c-e of FIG. 1. FIG. 2B may be described in conjunction with any of the layers 108a-c and/or any one of the compute nodes 110a-f. The example of FIG. 2B includes the example distribution memory 206, the example processing elements (PEs) 208, the example input memory 210, and the example output memory 212 and the example programmable sampling unit (PSU) 214 of FIG. 2. Additionally, the example of FIG. 2B includes an example squaring logic circuitry 220, example multiplexers (MUXs) 222, 224, 230, an example MUX control circuitry 225, example RAM 226, 228, example Gaussian sampler circuitry 232, and example average circuitry 234. Although the example of FIG. 2B includes three processing elements and three tiles to obtain data from three storage elements and output data into three storage elements, there may be any number of storage elements, processing elements in any number of tiles.

As described above, the example IRAM 210 stores the input and/or activation data. The example IRAM 210 outputs the stored input and/or activation data to the example squaring logic circuitry 220 and a first input of the example MUX 222. The example squaring logic circuitry 220 performs a mathematical squaring function to multiply the input data to itself (e.g., to generate I²). The example squaring logic circuitry 220 outputs the squared input to a second input of the example MUX 222.

The example MUX 222 of FIG. 2B receives the input data (I) and the squared input data (I²). Additionally, the example MUX 222 obtains a control signal via a select input from the example MUX control circuitry 225. As further described below, the example MUX control circuitry 225 controls the example MUX 222 to cause the node 110d to operate as a standard DNN (e.g., by applying a preset weight to the input) or a B-DNN (e.g., by applying a weight that corresponds to a probability distribution defined by the mean and variance). When operating as a DNN, the example MUX 222 outputs a control signal (e.g., a logic low) to the select input of the MUX 222 to cause the MUX 222 to output the input data (I) to the example PE 208. When operating as a B-DNN, the example MUX 222 outputs a control signal (e.g., a logic high) to the select input of the MUX 222 to cause the MUX 222 to output the input data (I) and the squared input data (I²) to the example PE 208. The MUX 222 may include additional components to allow it to output both input data when operating in B-DNN mode.

The example distribution memory 206 of FIG. 2B obtains the mean and variance value(s) from the system memory 106 (e.g., via the weight buffer 204). The example distribution memory 206 stores the mean in the example RAM 226 and the variance in the example RAM 228. The RAM 228 may be replaced with any type of memory, registers, and/or storage. In this manner, the PEs 208 can access the mean and variance value(s) from the distribution memory 206 to apply to the input data (e.g., I and/or I²) and output the mean-based results (β) and/or variance-based results (δ²) to the example distribution buffer 202, as further described below.

The example MUX 224 of FIG. 2B receives the mean value and the variance value from the example RAMS 226, 228. Additionally, the example MUX 224 obtains a control signal via a select input from the example MUX control circuitry 225. As further described below, the example MUX control circuitry 225 controls the example MUX 224 to cause the node 110d to operate as a standard DNN (e.g., by applying a preset weight to the input) or a B-DNN (e.g., by applying a weight that corresponds to a probability distribution defined by the mean and variance). When operating as a DNN, the example MUX 224 outputs a control signal (e.g., a logic low) to the select input of the MUX 224 to cause the MUX 224 to output the mean value to the example PE 208. When operating as a B-DNN, the example MUX 224 outputs a control signal (e.g., a logic high) to the select input of the MUX 224 to cause the MUX 224 to output the mean value and the variance value to the example PE 208. The MUX 224 may include additional components to allow it to output both input data when operating in B-DNN mode.

The example PE 208 of FIG. 2B applies (e.g., multiplies) the mean and/or variance values corresponding to a single probability distribution to the input value and/or squared input value to generate output data (e.g., mean-based data (the product of the mean and the input data, referred herein as β) and/or variance-based data (the product of the variance and the input data, referred to herein as δ²)). For example, when operating as a DNN, the PE 208 obtains the input value and the mean value and multiplies them to generate an output value. When operating as a B-DNN, the PE 208 obtains the input value, the squared input value, the mean, and the variance. The example PE 208 may generate the means-based value (β) by multiplying the mean by the input value (μI). The example PE 208 may generate the variance-based value (δ²) by multiplying the variance value by the squared input value (I²σ²).The example PE 208 outputs the generated value to the example

ORAM 212 to be stored.

The example MUX control circuitry 225 of FIG. 2B controls what is output by the example MUXs 222, 224, 230 by transmitting one or more control signal to select input(s) of the example MUX(s) 222, 224, 230. As described above, the example MUX control circuitry 224 controls the example MUXs 222, 224 to cause the node 110c to act as a DNN or a B-DNN using one or more control signals. As further described below, the example MUX control circuitry 225 outputs one or more control signals to allow the PSU 214 to generate outputs for multiple nodes 110c-e in series.

The example MUX 230 of FIG. 2B obtains outputs from the example ORAMs 212 of the different nodes 110c-e corresponding to the M tiles. The example MUX control circuitry 225 transmits a control signal(s) to a select input of the example MUXs 230 to allow the PSU 214 to generate an output that corresponds to a probability distribution for a single node at a time. In this manner, the nodes 110c-e can generate the mean-based and variance-based values in parallel, and all the nodes(s) 110c-e can share a single PSU 214 to generate the corresponding outputs.

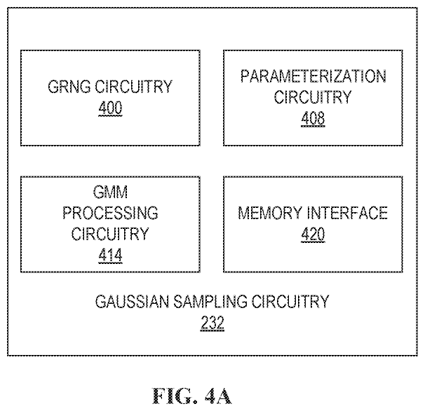

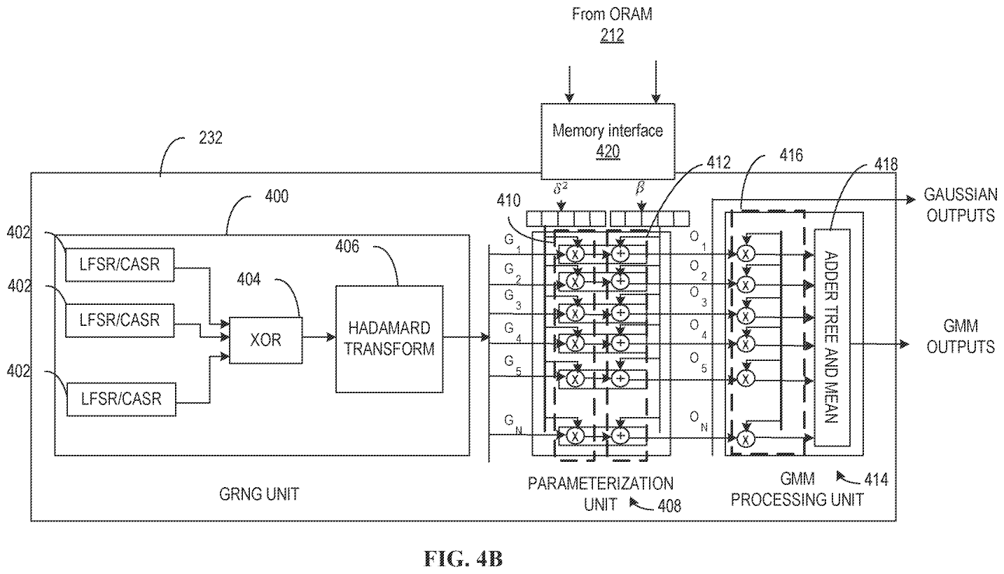

The example Gaussian sample circuitry 232 of FIG. 2B obtains the mean-based value and the variance-based value from the example ORAM 212. Additionally, the Gaussian sample circuitry 232 generates random/pseudo-random numbers that are applied to the mean-based value and the variance-based value resulting in an output that corresponds to input applied to a weight that follows a probability distribution defined by the mean and the variance. The Gaussian sample circuitry 232 may generate a plurality of random/pseudo-random numbers that correspond to a plurality of weighted outputs that correspond to the single probability distribution. In this manner, multiple outputs can be generated using a single input value. In some examples, the Gaussian sample circuitry 232 can generate one or more GMM-based outputs that correspond to a mixed probability distribution (e.g., with two or more means and/or two or more variances). The example Gaussian sample circuitry 232 is further described below in conjunction with FIGS. 4A and/or 4B.

The example average circuitry 234 of FIG. 2B averages (e.g., a mathematical average or mean) the multiple outputs of the example Gaussian sample circuitry 232 to generate a final output value that corresponds to the input value being applied to a weight that corresponds to a probability distribution. The example average circuitry 234 outputs the average (e.g., the final output) to the example ORAM 212 to be stored in the example ORAM 212. The example ORAM 212 outputs the final output value as a value corresponding to a classification and/or to be input into one or more of the layers 108a-108c.

FIG. 3 illustrates an example of the processing example input activations 300 to generate output values for a subsequent layer. FIG. 3 includes an example layer processing order 302. Although the example of FIG. 3 is described in conjunction with the example activations 300, the activations 300 may be replaced with input values (e.g., for a first layer of the BDNN 104). The example of FIG. 3 includes the example PEs 208 of FIGS. 2A and 2B.

The example activations 300 are stored in the example input memory 210 of FIGS. 2A and 2B. The set include p activations corresponding to subsets of the N forward passes (e.g., where N can be any number of forward passes, such as 1, 2, 3, 4, etc.), resulting in N total processed activations. The first subset of forward passes corresponds to activations [1, p] to be processed by tile 0, the second subset of forward passes corresponds to activations [p+1, 2p] to be processed by tile 1, . . . the Xth subset of forward passes corresponds to activations [N−p+1, N] to be processed at tile M. The activations may correspond to any type of data. For example, the activations may be pixel data when the activations correspond to image and/or video data. Each activation corresponds to a set of data broken into sub data that is stored in the example input memory 210. For example, if there are 16 input memories 210 connected to 16 PEs 208, then activation 1 is split into I₁, I₂, I₃ . . . I₁₆, activation 2 is split into I₁, I₂, . . . I₁₆, etc.

The example PEs 208 of the first tile (Tile 0) FIG. 2A and/or 2B access the first p activations [1−p] (e.g., corresponding to different forwarded passes or different images in a batch) from the input memory 210 and the first mean value(s) and variance value(s) from the distribution memory 206. As described above, the one or more mean and variance values corresponding to a single probability distribution.

The example PEs 208 of FIG. 3 apply the set of mean and variance value(s) to the corresponding subset of the activations. For example, the first PE 208 of the first compute node (e.g., tile 0) applies the mean and variance to the first data point (I₁and I₁²) of the first p activation (activation 1 through activation p), the second PE 208 applies the means and variance to the second datapoint (I₂) of the firstp activations (activation 1 through activation p), . . . , and the Xth PE 208 applies the mean and variance to the Xth datapoint (I_{X}) of the first p activations (activation 1 through activation p) , where each activation corresponds to a different image in a batch or a different forward pass. In some examples, at the same time, the second compute node 110d (e.g., tile 1) of the same layer 108b applies the mean and variance to the corresponding second subset of activations. For example, the first PE 208 of the second compute node (e.g., tile 1) applies the mean and variance to the first data point (I1) of the activations p+1 through 2p, the second PE 208 applies the mean and variance values to the second datapoint (I₂) of the first p activations p+1 through 2p, etc. After the mean and variance values are applied to the activations, the output data (e.g., the mean-based data and the variance-based data) is stored in the example output memory 212. The PSU 214 obtains the mean-based data and variance-based data from the output memory 212, generates multiple outputs using Gaussian samples and averages the result to generate a single output (stored in the example output memory 212). The output is passed to a subsequent layer (or passed back to the input memory 210 or input memory of a previous layer for a subsequent iteration). After storing the output in the output memory 212, the example PEs 208 can process a subsequent image(s) and/or forward pass using the same or updated weights.

FIG. 4A is a block diagram of the example Gaussian sampler circuitry 232 of FIG. 2B. The example Gaussian sampler circuitry 232 includes an example Gaussian random number generator (GRNG) circuitry 400, an example parameterization circuitry 408, an example GMM processing circuitry 414, and an example memory interface 420.

The example GRNG circuitry 400 of FIG. 4A generates a random sequence of numbers (e.g., an array of numbers). The GRNG circuitry 400 outputs the plurality of random numbers to the example parameterization circuitry 408. The example parameterization circuitry 408 applies plurality of random numbers to the mean-based value and the variance-based value (e.g., from the memory interface 420). For example the parameterization circuitry 408 may multiply each of the plurality of random numbers by the variance-based value and add the mean-based value to the products to generate a plurality of outputs. In some examples, the outputs are stored based in the example ORAM 212 via the memory interface 420. In some examples, the GMM processing circuitry 414 generates GMM outputs based on the outputs. In GMM mode, the PSU(s) 200 generate(s) multiple outputs and/or samples that correspond to a single mixture model probability distribution corresponding to two or more means and two or more variances. For GMM mode, the outputs are output into the example GMM processing circuitry 414 to generate the sample that correspond to the multi-model distribution. The example GMM processing circuitry 414 generates outputs and/or samples that correspond to a mixture model probability distribution (e.g., a Gaussian probability distribution with two or more means and/or variance values). In some examples, the compute nodes may be trained to generate outputs that correspond to a mixture model distribution. The example Gaussian sampler circuitry 232 is further described below in conjunction with FIG. 4B.

FIG. 4B is a block diagram of the example Gaussian sampler circuitry 232 of FIG. 2B. The example Gaussian sampler circuitry 232 includes an example Gaussian random number generator (GRNG) circuitry 400, example registers 402, an example logic gate 404, an example Hadamard transform circuit 406, an example parameterization circuitry 408, an example multiplication array 410, an example addition array 412, an example GMM processing circuitry 414, an example multiplier array 416, an example adder tree and mean circuitry 418, and an example memory interface 420.

The example GRNG circuitry 400 of FIG. 4B generates a random sequence of numbers (e.g., an array of numbers). In some examples, the GRNG circuitry 400 is a circuit. The numbers may be in any format (e.g., fixed point, floating point, etc.). The example GRNG circuitry 400 includes the example registers 402. The example GRNG circuitry 400 includes the example registers 402. The registers 402 may be linear feedback shift registers, cellular automata shift registers, and/or any other type of shift register. The example registers 402 may be variable length and concatenated to form a long uniform pseudo random sequence. The length of the individual units may be co-prime of each other to ensure pseudo randomness across the long sequence. The registers 402 may output pseudo random sequence that is N-bits long, where in Nis a power of 2. The multiple outputs of the registers 402 are input into the example logic gate 404.

The example logic gate 404 of FIG. 4B performs an exclusive OR (XOR) function based on the multiple outputs of the registers 402. The output of the logic gate 404 (e.g., the XOR of the multiple outputs of the registers 402) is a N-bit pseudo random sequence that is supplied to the example Hadamard transform circuit 406. The Hadamard transform circuit 406 converts the N-bit pseudo random sequence output by the logic gate 404 to a (N+k) bit Gaussian pseudo random sequence (e.g., G1-GN), where k is the number of stages in the Hadamard Transform circuit 406. The different number of the sequence (G₁-G_{N}) output of the Hadamard transform circuit 406 have a zero mean and unit variance. The output sequence is input into the example parameterization circuitry 408.

The example parameterization circuitry 408 generates multiple weights in parallel (e.g., simultaneously) that correspond to a probability distribution based on a single mean and variance value. The example parameterization circuitry 408 obtains the single mean and variance value from the system memory 106 and/or the distribution memory 206 via the memory interface 420. To generate the weights, the parameterization circuitry 408 multiplies the variance by each of the numbers in the sequence (G₁-G_{N}) output by the GRNG circuitry 400 and adds the mean to the resulting product. For example, the multiplier array 410 multiplies the single variance value (e.g., from the system memory 106 for FIG. 2A and/or from the distribution buffer 202 for FIG. 2B) to each of the number (G₁-G_{N}) of the output sequence from the GRNG circuitry 400 to generate an array of N products. The adder array 412 adds the single mean value to the array of products to generate N weights. The N weights is represented below based on Equation 4.

Oₙ=(Gₙ)(δ²)+β, for n=1, 2, . . . N (Equation 4)

In Equation 4, O is the output, G is a number of the sequence output by the GRNG circuitry 400, β is the mean-based value stored in the ORAM 212 (e.g., μI) and δ² is the variance-based value stored in the ORAM 212 (e.g., I²σ²).The example parameterization circuitry 208 supports FP16 representation formal, INT8 representation format, and/or any other representation format. For some representation formals (e.g., FP16), floating point conversion circuitry may be included to convert the fixed point output of the GRNG circuitry 400 to floating point prior to inputting into the example parameterization circuitry 408. In some examples, the output of the Hadamard transform circuit 406 includes a total number of numbers in the sequence sufficient to apply to N forward passes and/or N activations. In this manner, the parameterization circuitry 408 can generate a plurality of outputs for the N activations. Thus, one or more of the PEs 208 can process N activations corresponding to N forward passes or N images in a batch using the N outputs that correspond to a single probability distribution. The output of the parametrization circuitry (e.g., the outputsO₁-O_{N}), may be output to the example average circuitry 234 of FIG. 2B and/or to the example GMM processing circuitry 414.

The PSU(s) 200 of FIG. 2A and/or 2B can operate in Gaussian mode or GMM mode. In Gaussian mode, the PSU(s) 200 generate(s) multiple outputs and/or samples that correspond to a single probability distribution corresponding to with one mean and one variance. In GMM mode, the PSU(s) 200 generate(s) multiple outputs and/or samples that correspond to a single mixture model probability distribution corresponding to two or more means and two or more variances. For GMM mode, the outputs are output into the example GMM processing circuitry 414 to generate the sample that correspond to the multi-model distribution.

The example GMM processing circuitry 414 of FIG. 4B is used to generate outputs and/or samples that correspond to a mixture model probability distribution (e.g., a Gaussian probability distribution with two or more means and/or variance values). In some examples, the compute nodes may be trained to generate outputs that correspond to a mixture model distribution. In such examples, the GMM processing circuitry 414 can access the additional mean-based value(s) and/or variance-based value(s) from the system memory 106, the distribution buffer 202, and/or the ORAM 212 (e.g., after being processed by the PE 208) that correspond to the mixture model distribution. A GMM distribution with M modes is represented in the below Equation 5.

N_{GMM}=ΣᵢϕᵢN(βᵢ, δᵢ²) (Equation 5)

In the above-Equation 2, βᵢ and δᵢ² are the mean and variance-based values of the i^{th} Gaussian distribution in the GMM and ϕᵢ is the weight of that distribution. GMM is characterized by multiple trained distributions to help improve the accuracy of Neural networks. The example GMM processing circuitry 414 generates the GMM based on the below Equation 6, which corresponds to a rewritten version of Equation 5.

N_{GMM}=N(Σᵢϕᵢβᵢ, Σᵢϕᵢ²δᵢⱼ²) (Equation 6)

For example, the MINI processing circuitry 414 includes an example multiplier array 416 that multiplies the output of the example parameterization circuitry 408 by the ϕ_{1-M} additional variance-based value(s). The example adder tree and mean circuit 418 obtains the products (e.g., the outputs multiplied by ϕᵢ) and accumulates to generate samples representative of the mixture model distribution. The example adder tree and means circuit 418 outputs the GMM based outputs to the example distribution buffer 202.

The example memory interface 420 of FIG. 4B accesses mean-based value(s) and/or variance-based value(s) from the example ORAM 212. The example memory interface 420 provides the obtained and/or accessed mean value(s) and/or variance value(s) to the example parameterization circuitry 408 and/or the example GMM processing circuitry 414 for the generation of the weights and/or samples that correspond to a single probability distribution.

While an example manner of implementing the BDNN 104 of FIG. 1 is illustrated in FIGS. 1-4, one or more of the elements, processes and/or devices illustrated in FIGS. 1-4 may be combined, divided, re-arranged, omitted, eliminated and/or implemented in any other way. Further, the example system memory 106, the example layers 108a-c, the example compute nodes 110c-e, the example PSU 214, the example wight buffer 202, the example distribution memory 206, the example PEs 208, the example input memory 210, the example output memory 212, the example GRNG circuitry 400, the example registers 402, the example logic gate 404, the example Hadamard transform circuitry 406, the example parameterization circuitry 408, the example multiplier array 410, the example adder array 412, the example GMM processing circuitry 414, the example multiplier array 416, the example adder tree and mean circuitry 418, the example memory interface 420, and/or, more generally, the example BDNN 104 of FIGS. 1-4 may be implemented by hardware, software, firmware and/or any combination of hardware, software and/or firmware. Thus, for example, any of the example system memory 106, the example layers 108a-c, the example compute nodes 110c-e, the example PSU 214, the example wight buffer 202, the example distribution memory 206, the example PEs 208, the example input memory 210, the example output memory 212, the example GRNG circuitry 400, the example registers 402, the example logic gate 404, the example Hadamard transform circuitry 406, the example parameterization circuitry 408, the example multiplier array 410, the example adder array 412, the example GMM processing circuitry 414, the example multiplier array 416, the example adder tree and mean circuitry 418, the example memory interface 420, and/or, more generally, the example BDNN 104 of FIGS. 1-4 could be implemented by one or more analog or digital circuit(s), logic circuits, programmable processor(s), programmable controller(s), graphics processing circuitry(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example system memory 106, the example layers 108a-c, the example compute nodes 110c-e, the example PSU 214, the example wight buffer 202, the example distribution memory 206, the example PEs 208, the example input memory 210, the example output memory 212, the example GRNG circuitry 400, the example registers 402, the example logic gate 404, the example Hadamard transform circuitry 406, the example parameterization circuitry 408, the example multiplier array 410, the example adder array 412, the example GMM processing circuitry 414, the example multiplier array 416, the example adder tree and mean circuitry 418, the example memory interface 420, and/or, more generally, the example BDNN 104 of FIGS. 1-4 is/are hereby expressly defined to include a non-transitory computer readable storage device or storage disk such as a memory, a digital versatile disk (DVD), a compact disk (CD), a Blu-ray disk, etc. including the software and/or firmware. Further still, the example BDNN 104 of FIGS. 1-4 may include one or more elements, processes and/or devices in addition to, or instead of, those illustrated in FIGS. 1-3, and/or may include more than one of any or all of the illustrated elements, processes, and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

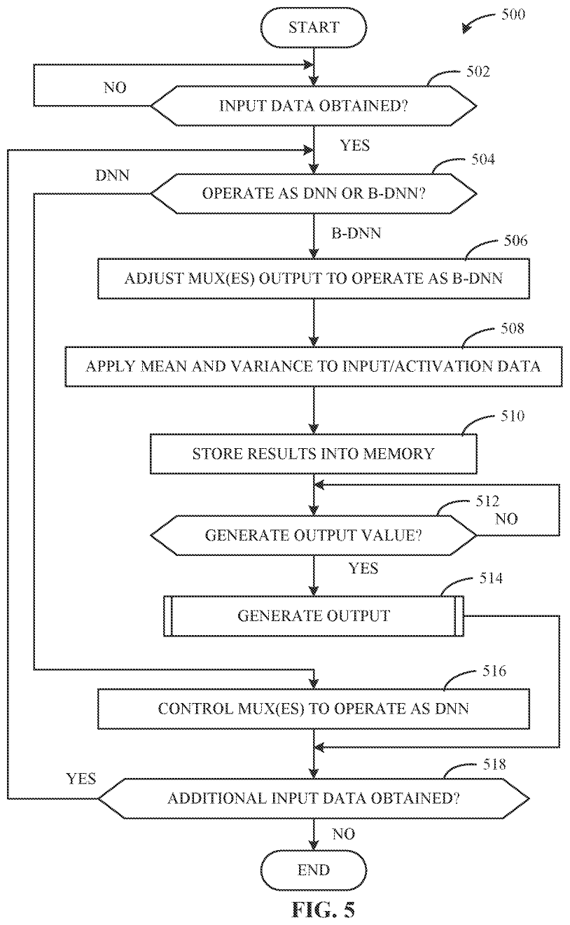

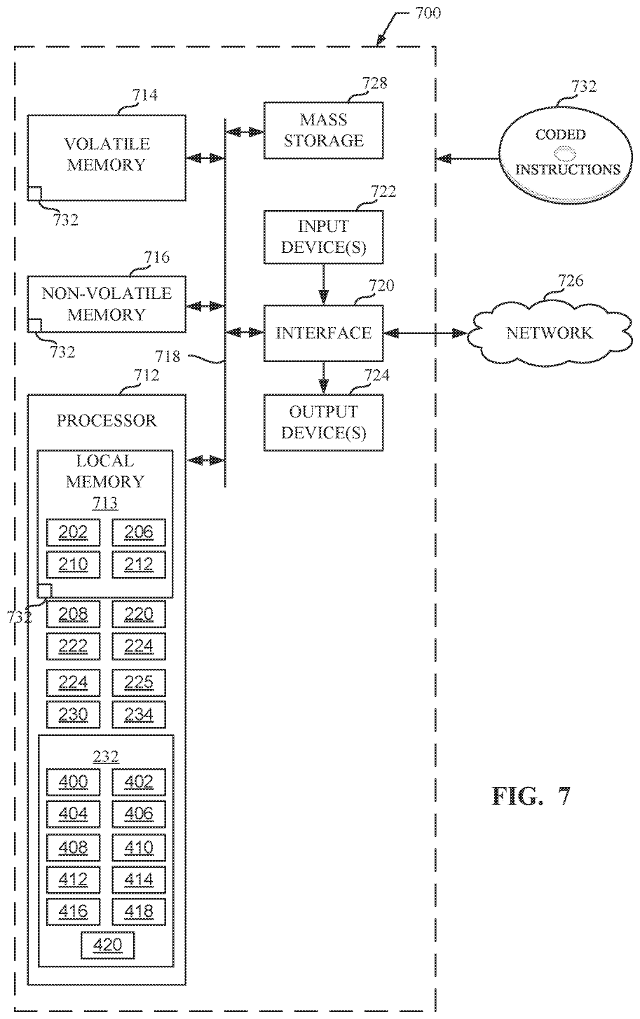

Flowchart representative of example hardware logic, machine readable instructions, hardware implemented state machines, and/or any combination thereof for implementing the example BDNN 104 of FIGS. 1-4 are shown in FIGS. 5 and/or 6. The machine readable instructions may be one or more executable programs or portion(s) of an executable program for execution by a computer processor such as the processor 712 shown in the example processor platform 600 discussed below in connection with FIG. 7. The program may be embodied in software stored on a non-transitory computer readable storage medium such as a CD-ROM, a floppy disk, a hard drive, a DVD, a Blu-ray disk, or a memory associated with the processor 712, but the entire program and/or parts thereof could alternatively be executed by a device other than the processor 712 and/or embodied in firmware or dedicated hardware. Further, although the example program is described with reference to the flowchart illustrated in FIGS. 5 and/or 6, many other methods of implementing the example BDNN 104 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

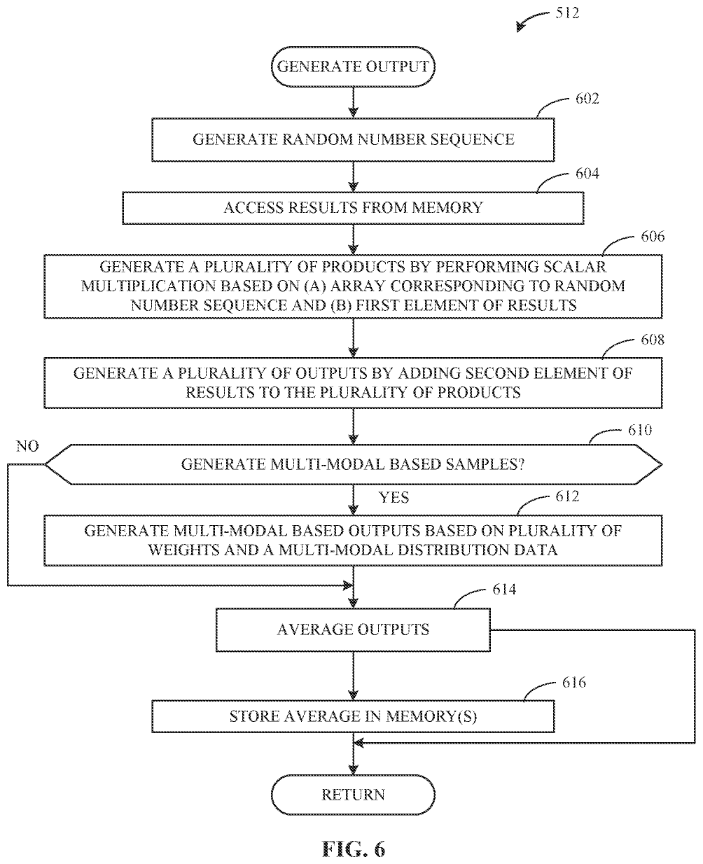

As mentioned above, the example processes of FIGS. 5-6 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions 500 which may be executed to implement any one of the layers 108a-c of FIGS. 1-4 to generate outputs corresponding to a single probability distribution based on inputs and/or activations. Although the instructions 500 are described in conjunction with the example layer 108b of FIGS. 1-4, the instructions 500 may be described in conjunction with any neuron in any type of neural network or other AI-based model using any type of data (e.g., input data or activations).

At block 502, the example MUX control circuitry 225 determines if input data has been obtained (e.g., stored in the input memory 210). If the example MUX control circuitry 225 has determined that input data has not been obtained (block 502: NO), control returns to block 502 until input data has been obtained. If the example MUX control circuitry 225 has determined that input data has been obtained (block 502: YES), the example MUX control circuitry 225 determines if the layer 108b should operate as a DNN or a B-DNN (block 504) (e.g., based on user preferences, manufacturer preferences, and/or instructions from another component).

If the example MUX control circuitry 225 determines that layer 108b should act as a DNN (block 504: DNN), the example MUX control circuitry 225 controls the MUXs 222, 224 to operate in a DNN mode (block 516). For example, the MUX control circuitry 225 outputs one or more control signals to the select inputs of the MUXs 222, 224 to cause the MUXs to output the mean and the input data to the example PE 208. If the example MUX control circuitry 225 determines that layer 108b should act as a B-DNN (block 504: B-DNN), the example MUX control circuitry 225 controls the MUXs 222, 224 to operate in a B-DNN mode (block 506). For example, the MUX control circuitry 225 outputs one or more control signals to the select inputs of the MUXs 222, 224 to cause the MUXs to output the mean, variance, input, and squared input to the example PE 208.

At block 508, the example PEs 208 apply the mean and variance values to the input/activation data. For example, one or more of the PEs 208 can multiply the mean to an input/activation value and multiply the variance to the square of the input/activation value to generate a mean-based value and a variance-based value. At block 510, the example output memory 212 stores the results (e.g., the mean-based value and the variance-based value). At block 512, the example MUX control circuitry 225 determines if it is time to generate the output value based on the mean-based value and variance-based value stored in the example output memory 212. As described above, if the PSU 214 computes weights for all the nodes in a layer, then the MUX control circuitry 225 controls the MUXs 230 so that the PSU 214 handles all the output data for each node in series (e.g., processing data for the first node at time one, the second node at time two, the third node at time three, etc.).

If the example MUX control circuitry 225 determines that it is not time to generate the output value (block 512: NO), control returns to block 512 until it is time. If the example MUX control circuitry 225 determines that it is time to generate the output value (block 512: YES), the MUX control circuitry 225 outputs one or more control signals to the select input of the example MUXs 230 so that the PSU 214 can generate the output based on the information of the node 110c and the example PSU generates the output (block 514), as further described below in conjunction with FIG. 6.

At block 518, the example input memory 210 determines if additional input data has been obtained (e.g., stored in the input memory 210). If the example input memory 210 has determined that input data has not been obtained (block 502: NO), the instructions end. If the example input memory 210 has determined that additional input data has been obtained (block 502: YES), control returns to block 504.

FIG. 6 is a flowchart representative of example machine readable instructions 512 which may be executed to implement any one of the layers 108a-c of FIGS. 1-4 to generate an output, as described above in conjunction with block 512. Although the instructions 512 are described in conjunction with the example layer 108b of FIGS. 1-4, the instructions 512 may be described in conjunction with any neuron in any type of neural network or other AI-based model using any type of data (e.g., input data or activations).

At block 602, the example GRNG circuitry 400 generates a random number (or pseudo random number) sequence (e.g., including a plurality of numbers G₁-G_{N} corresponding to the number of activations to be processed at the entire layer 108b or the number of activations to be processed by a particular one of the compute nodes 110c-e. The GRNG circuitry 400 may generate the random/pseudo random number sequence based on a Hadamard transform of an XOR operation of outputs of multiple registers 402, as described above in conjunction with FIG. 4B. At block 604, the example parameterization circuitry 408 access the results (e.g., the mean-based value and the variance-based value) from the output memory 212.

At block 606, the example multiplier array 410 generates a plurality of products (δ²G₁, δ²G₂, . . . , δ²G_{N}) by performing a scalar multiplication based on (a) an array of the random/pseudo random numbers from the random/pseudo random number sequence (e.g., G₁-G_{N}) and (b) the first element of the results (e.g., the variance-based value (e.g., δ²)). At block 608, the example adder array 412 generates a plurality of outputs (e.g., O₁-O_{N}) corresponding to the single mean-based value (β) and variance-based value (δ²) by adding the second element of the results (e.g., the mean-based value (β)) to the plurality of products. Because the random/pseudo random number sequence includes N total numbers, the adder array 412 generate N weights corresponding to a probability distribution based on the single mean and variance value.

At block 610, the example GMM processing circuitry 414 determines the PSU 214 is operating in GMM model (e.g., to generate a probability distribution corresponding to multiple modes and variances). For example, the system memory 106 may store an indication that the probability distribution to be used is mixture model and/or may include multiple means/mean-based values and variances/variance-based values when the probability distribution to be used is a mixture model distribution. If the example GMM processing circuitry 414 determines that mixture model samples are not needed (block 610: NO), control continues to block 614.

If the example GMM processing circuitry 414 determines that mixture model samples are needed (block 610: YES), the example GMM processing circuitry 414 generates mixture model based outputs based on the plurality of outputs and mixture model distribution data (block 612). For example, the array multiplier 416 multiplies the outputs O₁-O_{N} by the value ϕ_{i-N} (e.g., which is stored in the example output memory 212) to generate products corresponding to the mixture model distribution. Additionally, the example adder tree and mean circuit 418 adds one or more additional means/mean-based values to the mixture model based products to generate the mixture model samples. At block 614, the example average circuitry 234 averages the outputs by performing a mathematical average and/or mean-based on the N outputs. At block 616, the example output memory 212 stores the average as the output of the node. After 616, control returns to block 514 of FIG. 5.

FIG. 7 is a block diagram of an example processor platform 700 structured to execute the instructions of FIGS. 5-6 to implement the example BDNN 104 of FIGS. 1-4 The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 700 of the illustrated example includes a processor 712. The processor 712 of the illustrated example is hardware. For example, the processor 712 can be implemented by one or more integrated circuits, logic circuits, microprocessors, GPUs, DSPs, or controllers from any desired family or manufacturer. The hardware processor may be a semiconductor based (e.g., silicon based) device. In this example, the processor 712 implements at least one of the example layers 108a-c, the example compute nodes 110c-e, the example PSU 214, the example PEs 208, the example squaring circuitry 220, the example MUXs 222, 224, 230, the example MUX control circuitry 225, the example averaging circuitry 234, the example GRNG circuitry 400, the example logic gate 404, the example Hadamard transform circuitry 406, the example parameterization circuitry 408, the example multiplier array 410, the example adder array 412, the example GMM processing circuitry 414, the example multiplier array 416, the example adder tree and mean circuitry 418, the example memory interface 420 of FIGS. 1-4.

The processor 712 of the illustrated example includes a local memory 713 (e.g., a cache). In the example of FIG. 7, the local memory 713 implements the example distribution buffer 202, the example distribution memory 206, the example input memory 210, the example output memory 212, and the example registers 402 of FIGS. 2A, 2B, 3, and/or 4. The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 716 may be implemented by flash memory and/or any other desired type of memory device. Access to the main memory 714, 716 is controlled by a memory controller. The example local memory 713, the example volatile memory 714, and/or the example non-volatile memory 716 can implement the memory 106 of FIG. 1. Any one of the example volatile memory 714, the example non-volatile memory 716, and/or the example mass storage 728 may implement the example system memory 106 of FIGS. 1-2B.

The processor platform 700 of the illustrated example also includes an interface circuit 720. The interface circuit 720 may be implemented by any type of interface standard, such as an Ethernet interface, a universal serial bus (USB), a Bluetooth® interface, a near field communication (NFC) interface, and/or a PCI express interface.

In the illustrated example, one or more input devices 722 are connected to the interface circuit 720. The input device(s) 722 permit(s) a user to enter data and/or commands into the processor 712. The input device(s) can be implemented by, for example, an audio sensor, a microphone, a camera (still or video), a keyboard, a button, a mouse, a touchscreen, a track-pad, a trackball, and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, and/or speaker. The interface circuit 720 of the illustrated example, thus, typically includes a graphics driver card, a graphics driver chip and/or a graphics driver processor.

The interface circuit 720 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 726. The communication can be via, for example, an Ethernet connection, a digital subscriber line (DSL) connection, a telephone line connection, a coaxial cable system, a satellite system, a line-of-site wireless system, a cellular system, etc.

The processor platform 700 of the illustrated example also includes one or more mass storage devices 728 for storing software and/or data. Examples of such mass storage devices 728 include floppy disk drives, hard drive disks, compact disk drives, Blu-ray disk drives, redundant array of independent disks (RAID) systems, and digital versatile disk (DVD) drives.

The machine executable instructions 732 of FIGS. 5-6 may be stored in the mass storage device 728, in the volatile memory 714, in the non-volatile memory 716, and/or on a removable non-transitory computer readable storage medium such as a CD or DVD.

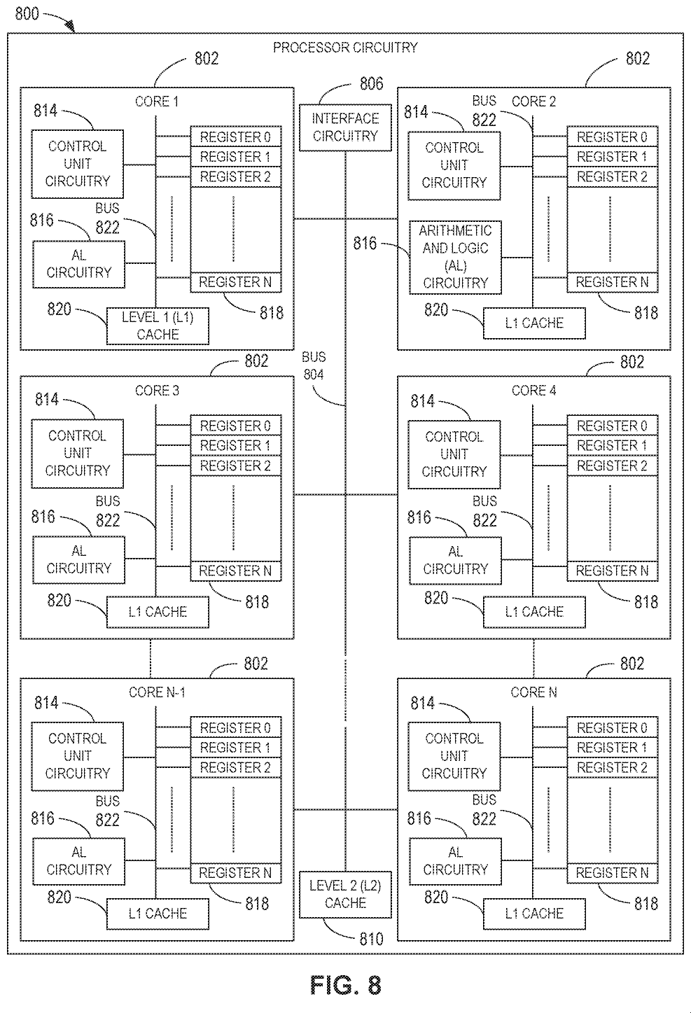

FIG. 8 is a block diagram of an example implementation of the processor circuitry 712 of FIG. 7. In this example, the processor circuitry 712 of FIG. 7 is implemented by a microprocessor 800. For example, the microprocessor 900 may implement multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 5-6.

The cores 802 may communicate by an example bus 804. In some examples, the bus 804 may implement a communication bus to effectuate communication associated with one(s) of the cores 802. For example, the bus 804 may implement at least one of an Inter-Integrated Circuit (I2C) bus, a Serial Peripheral Interface (SPI) bus, a PCI bus, or a PCIe bus. Additionally or alternatively, the bus 804 may implement any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1data cache and an L1instruction cache), the microprocessor 800 also includes example shared memory 810 that may be shared by the cores (e.g., Level 2 (L2_cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the L1cache 820, and an example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating point operations. In yet other examples, the AL circuitry 816 may include first AL circuitry that performs integer based operations and second AL circuitry that performs floating point operations. In some examples, the AL circuitry 816 may be referred to as an Arithmetic Logic Unit (ALU). The registers 818 are semiconductor-based structures to store data and/or instructions such as results of one or more of the operations performed by the AL circuitry 816 of the corresponding core 802. For example, the registers 818 may include vector register(s), SIMD register(s), general purpose register(s), flag register(s), segment register(s), machine specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure including distributed throughout the core 802 to shorten access time. The bus 820 may implement at least one of an I2C bus, a SPI bus, a PCI bus, or a PCIe bus

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

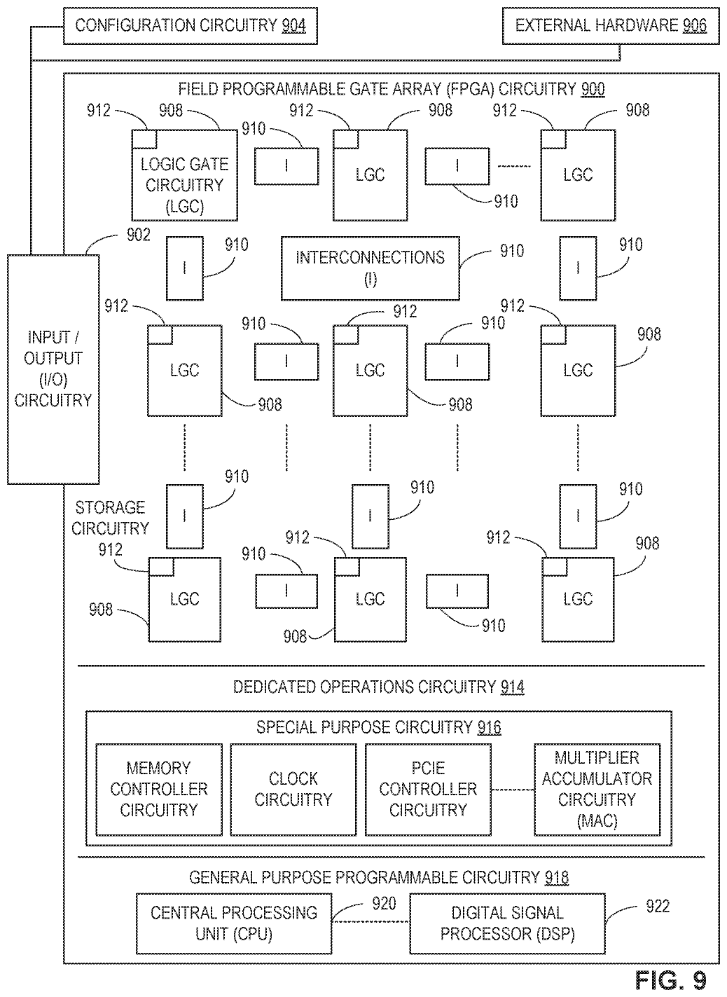

FIG. 9 is a block diagram of another example implementation of the processor circuitry 712 of FIG. 7. In this example, the processor circuitry 712 is implemented by FPGA circuitry 900. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the machine readable instructions in hardware and, thus, can often execute the operations faster than they could be performed by a general purpose microprocessor executing the corresponding software.

More specifically, in contrast to the microprocessor 800 of FIG. 8 described above (which is a general purpose device that may be programmed to execute some or all of the machine readable instructions represented by the flowcharts of FIGS. 5-6 but whose interconnections and logic circuitry are fixed once fabricated), the FPGA circuitry 900 of the example of FIG. 9 includes interconnections and logic circuitry that may be configured and/or interconnected in different ways after fabrication to instantiate, for example, some or all of the machine readable instructions represented by the flowcharts of FIGS. 5-6. In particular, the FPGA 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the software represented by the flowcharts of FIGS. 5-6. As such, the FPGA circuitry 900 may be structured to effectively instantiate some or all of the machine readable instructions of the flowcharts of FIGS. 5-6 as dedicated logic circuits to perform the operations corresponding to those software instructions in a dedicated manner analogous to an ASIC. Therefore, the FPGA circuitry 900 may perform the operations corresponding to the some or all of the machine readable instructions of FIG. FIGS. 5-6 faster than the general purpose microprocessor can execute the same.

In the example of FIG. 9, the FPGA circuitry 900 is structured to be programmed (and/or reprogrammed one or more times) by an end user by a hardware description language (HDL) such as Verilog. The FPGA circuitry 900 of FIG. 9, includes example input/output (I/O) circuitry 902 to obtain and/or output data to/from example configuration circuitry 904 and/or external hardware (e.g., external hardware circuitry) 906. For example, the configuration circuitry 904 may implement interface circuitry that may obtain machine readable instructions to configure the FPGA circuitry 900, or portion(s) thereof In some such examples, the configuration circuitry 904 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 906 may implement the microprocessor 800 of FIG. 8. The FPGA circuitry 900 also includes an array of example logic gate circuitry 908, a plurality of example configurable interconnections 910, and example storage circuitry 912. The logic gate circuitry 908 and interconnections 910 are configurable to instantiate one or more operations that may correspond to at least some of the machine readable instructions of FIGS. 5-6 and/or other desired operations. The logic gate circuitry 908 shown in FIG. 9 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations. The logic gate circuitry 908 may include other electrical structures such as look-up tables (LUTs), registers (e.g., flip-flops or latches), multiplexers, etc.

The interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example Dedicated Operations Circuitry 914. In this example, the Dedicated Operations Circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the processor circuitry 712 of FIG. 7, many other approaches are contemplated. For example, as mentioned above, modern FPGA circuitry may include an on-board CPU, such as one or more of the example CPU 920 of FIG. 9. Therefore, the processor circuitry 712 of FIG. 7 may additionally be implemented by combining the example microprocessor 800 of FIG. 8 and the example FPGA circuitry 900 of FIG. 9. In some such hybrid examples, a first portion of the machine readable instructions represented by the flowcharts of FIGS. 5-6 may be executed by one or more of the cores 802 of FIG. 8 and a second portion of the machine readable instructions represented by the flowcharts of FIGS. 5-6 may be executed by the FPGA circuitry 900 of FIG. 9.

In some examples, the processor circuitry 712 of FIG. 7 may be in one or more packages. For example, the processor circuitry 800 of FIG. 8 and/or the FPGA circuitry 900 of FIG. 9 may be in one or more packages. In some examples, an XPU may be implemented by the processor circuitry 712 of FIG. 7, which may be in one or more packages. For example, the XPU may include a CPU in one package, a DSP in another package, a GPU in yet another package, and an FPGA in still yet another package.

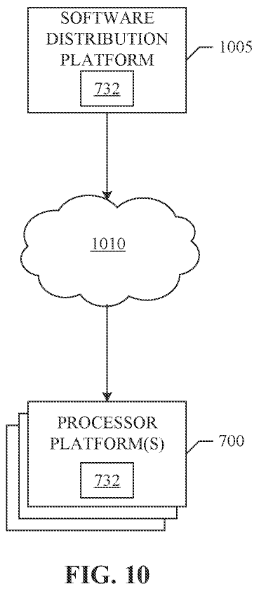

A block diagram illustrating an example software distribution platform 1005 to distribute software such as the example computer readable instructions 732 of FIG. 7 to third parties is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the computer readable instructions 732, which may correspond to the example computer readable instructions 500, 732 of FIGS. 5 and 7, as described above. The one or more servers of the example software distribution platform 1005 are in communication with a network 1010, which may correspond to any one or more of the Internet and/or any of the example networks 726 described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 732 from the software distribution platform 1005. For example, the software, which may correspond to the example computer readable instructions 732 of FIG. 7, may be downloaded to the example processor platform 1000, which is to execute the computer readable instructions 732 to implement the BDNN 104. In some example, one or more servers of the software distribution platform 1005 periodically offer, transmit, and/or force updates to the software (e.g., the example computer readable instructions 732 of FIG. 7) to ensure improvements, patches, updates, etc. are distributed and applied to the software at the end user devices.

Example methods, apparatus, systems, and articles of manufacture to provide a Bayesian compute unit with reconfigurable sampler and methods and apparatus to operate the same are disclosed herein. Further examples and combinations thereof include the following: Example 1 includes a node of a neural network to apply a plurality of weights in an artificial intelligence-based model, the node comprising a processor element to generate (a) a first element by applying a mean value to an activation and (b) a second element by applying a variance value to a square of the activation, the mean value and the variance value corresponding to a single probability distribution, a programmable sampling unit to generate a pseudo random number, and generate an output based on the pseudo random number, the first element, and the second element, wherein the output corresponds to the single probability distribution, and output memory to store the output.

Example 2 includes the node of example 1, wherein the processor element is to generate the first element by multiplying the mean value with the activation, and generate the second element by multiplying the variance value with the square of the activation.

Example 3 includes the node of example 1, wherein the programmable sampling unit is to generate the output by generating a product by multiplying the second element by the pseudo random number, and adding the first element by the product.

Example 4 includes the node of example 1, wherein the programmable sampling unit is to generate a plurality pseudo random numbers, the plurality of pseudo random numbers including the pseudo random number, generate a plurality of outputs, average the plurality of outputs, and generate the output based on the average.

Example 5 includes the node of example 1, wherein the programmable sampling unit is to generate a plurality of outputs for a plurality of nodes, the plurality of nodes including the node.

Example 6 includes the node of example 1, wherein the programmable sampling unit is to generate the pseudo random number by generating a pseudo random sequence using shift registers, adjust the pseudo random sequence by performing an exclusive OR (XOR) function to the pseudo random sequence, and convert the adjusted pseudo random sequence to a Gaussian pseudo random number sequence, the Gaussian pseudo random number sequence including the pseudo random number.

Example 7 includes the node of example 1, wherein the output memory is to output the output to input memory of a subsequent node.

Example 8 includes a non-transitory computer readable storage medium comprising instructions which, when executed, cause one or more processors to at least generate (a) a first element by applying a mean value to an activation and (b) a second element by applying a variance value to a square of the activation, the mean value and the variance value corresponding to a single probability distribution, generate a pseudo random number, generate an output based on the pseudo random number, the first element, and the second element, wherein the output corresponds to the single probability distribution, and output memory to store the output.

Example 9 includes the computer readable storage medium of example 8, wherein the instructions cause the one or more processors to generate the first element by multiplying the mean value with the activation, and generate the second element by multiplying the variance value with the square of the activation.

Example 10 includes the computer readable storage medium of example 8, wherein the instructions cause the one or more processors to generate the output by generating a product by multiplying the second element by the pseudo random number, and adding the first element by the product.

Example 11 includes the computer readable storage medium of example 8, wherein the instructions cause the one or more processors to generate a plurality pseudo random numbers, the plurality of pseudo random numbers including the pseudo random number, generate a plurality of outputs, average the plurality of outputs, and generate the output based on the average.

Example 12 includes the computer readable storage medium of example 8, wherein the instructions cause the one or more processors to generate a plurality of outputs for a plurality of nodes, the plurality of nodes including the node.

Example 13 includes the computer readable storage medium of example 8, wherein the instructions cause the one or more processors to generate the pseudo random number by generating a pseudo random sequence using shift registers, adjust the pseudo random sequence by performing an exclusive OR (XOR) function to the pseudo random sequence, and convert the adjusted pseudo random sequence to a Gaussian pseudo random number sequence, the Gaussian pseudo random number sequence including the pseudo random number.

Example 14 includes the computer readable storage medium of example 8, wherein the instructions cause the one or more processors to output the output to input memory of a subsequent node.

Example 15 includes an apparatus to apply a plurality of weights in an artificial intelligence-based model, the apparatus comprising at least one memory, and processor circuitry including one or more of at least one of a central processing unit, a graphic processing unit or a digital signal processor, the at least one of the central processing unit, the graphic processing unit or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations, or Application Specific Integrate Circuitry including logic gate circuitry to perform one or more third operations, the processor circuitry to at least one of perform at least one of the first operations, the second operations or the third operations to generate (a) a first element by applying a mean value to an activation and (b) a second element by applying a variance value to a square of the activation, the mean value and the variance value corresponding to a single probability distribution, generate a pseudo random number, and generate an output based on the pseudo random number, the first element, and the second element, wherein the output corresponds to the single probability distribution, and output memory to store the output.

Example 16 includes the apparatus of example 15, wherein the processor circuitry is to generate the first element by multiplying the mean value with the activation, and generate the second element by multiplying the variance value with the square of the activation.

Example 17 includes the apparatus of example 15, wherein the processor circuitry is to generate the output by generating a product by multiplying the second element by the pseudo random number, and adding the first element by the product.

Example 18 includes the apparatus of example 15, wherein the processor circuitry is to generate a plurality pseudo random numbers, the plurality of pseudo random numbers including the pseudo random number, generate a plurality of outputs, average the plurality of outputs, and generate the output based on the average.

Example 19 includes the apparatus of example 15, wherein the processor circuitry is to generate a plurality of outputs for a plurality of nodes, the plurality of nodes including the node.

Example 20 includes the apparatus of example 15, wherein processor circuitry is to generate the pseudo random number by generating a pseudo random sequence using shift registers, adjust the pseudo random sequence by performing an exclusive OR (XOR) function to the pseudo random sequence, and convert the adjusted pseudo random sequence to a Gaussian pseudo random number sequence, the Gaussian pseudo random number sequence including the pseudo random number.

Example 21 includes the apparatus of example 15, wherein processor circuitry is to output the output to input memory of a subsequent node.

From the foregoing, it will be appreciated that example methods, apparatus and articles of manufacture have been disclosed that provide a Bayesian compute unit with reconfigurable sampler and methods and apparatus to operate the same. BDNNs introduce uncertainty information to overcome the problems of overfitting and sensitivity to malicious attacks. Instead of using fixed weights, BDNNs introduce weights associated with conditioned probability distribution (e.g., the output weight may be a value within a probability distribution defined by a mean and standard deviation). Because BDNNs introduce some amount of randomness, BDNNs can be trained with smaller training data without sacrificing accuracy. However, traditional BDNNs distribute different mean and variance value(s) corresponding to different probability distributions for every compute node in a layer. Therefore, such traditional BDNNs require a large amount of bandwidth and take time to access the multiple mean and variance values from system memory to generate weights that correspond to the multiple different probability distributions.

Examples disclosed herein generate multiple weights that correspond to a single probability distribution (e.g., a Gaussian distribution and/or a GMM distribution). Examples disclosed herein utilize the apply a mean and variance to input and/or activation data and apply a Gaussian sampler to the mean-based data and/or variance to apply to a plurality of different activations in a compute node of a AI-based model (e.g., a neural network, a machine learning model, a deep learning model, etc.). In this manner, only mean value(s) and variance value(s) corresponding to a single distribution are accessed from system memory to apply to multiple different activations. Thereby reducing the bandwidth and time needed to access probability distribution data to generate weighted outputs. Accordingly, the disclosed methods, apparatus and articles of manufacture are accordingly directed to one or more improvement(s) in the functioning of a neural network.

It is noted that this patent claims priority from Indian Provisional Patent Application Number 202141024844 which was filed on Jun. 4, 2021, and is hereby incorporated by reference in its entirety.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. A node of a neural network to apply a plurality of weights in an artificial intelligence-based model, the node comprising:
a processor element to generate (a) a first element by applying a mean value to an activation and (b) a second element by applying a variance value to a square of the activation, the mean value and the variance value corresponding to a single probability distribution;
a programmable sampling unit to:
generate a pseudo random number; and
generate an output based on the pseudo random number, the first element, and the second element, wherein the output corresponds to the single probability distribution; and
output memory to store the output.

2. The node of claim 1, wherein the processor element is to:
generate the first element by multiplying the mean value with the activation; and
generate the second element by multiplying the variance value with the square of the activation.

3. The node of claim 1, wherein the programmable sampling unit is to generate the output by:
generating a product by multiplying the second element by the pseudo random number; and
adding the first element by the product.

4. The node of claim 1, wherein the programmable sampling unit is to:
generate a plurality pseudo random numbers, the plurality of pseudo random numbers including the pseudo random number;
generate a plurality of outputs;
average the plurality of outputs; and
generate the output based on the average.

5. The node of claim 1, wherein the programmable sampling unit is to generate a plurality of outputs for a plurality of nodes, the plurality of nodes including the node.

6. The node of claim 1, wherein the programmable sampling unit is to generate the pseudo random number by:
generating a pseudo random sequence using shift registers;
adjust the pseudo random sequence by performing an exclusive OR (XOR) function to the pseudo random sequence; and
convert the adjusted pseudo random sequence to a Gaussian pseudo random number sequence, the Gaussian pseudo random number sequence including the pseudo random number.

7. The node of claim 1, wherein the output memory is to output the output to input memory of a subsequent node.

8. A non-transitory computer readable storage medium comprising instructions which, when executed, cause one or more processors to at least:
generate (a) a first element by applying a mean value to an activation and (b) a second element by applying a variance value to a square of the activation, the mean value and the variance value corresponding to a single probability distribution;
generate a pseudo random number;
generate an output based on the pseudo random number, the first element, and the second element, wherein the output corresponds to the single probability distribution; and
output memory to store the output.

9. The computer readable storage medium of claim 8, wherein the instructions cause the one or more processors to:
generate the first element by multiplying the mean value with the activation; and
generate the second element by multiplying the variance value with the square of the activation.

10. The computer readable storage medium of claim 8, wherein the instructions cause the one or more processors to generate the output by:
generating a product by multiplying the second element by the pseudo random number; and
adding the first element by the product.

11. The computer readable storage medium of claim 8, wherein the instructions cause the one or more processors to:
generate a plurality pseudo random numbers, the plurality of pseudo random numbers including the pseudo random number;
generate a plurality of outputs;
average the plurality of outputs; and
generate the output based on the average.

12. The computer readable storage medium of claim 8, wherein the instructions cause the one or more processors to generate a plurality of outputs for a plurality of nodes, the plurality of nodes including the node.

13. The computer readable storage medium of claim 8, wherein the instructions cause the one or more processors to generate the pseudo random number by:
generating a pseudo random sequence using shift registers;
adjust the pseudo random sequence by performing an exclusive OR (XOR) function to the pseudo random sequence; and
convert the adjusted pseudo random sequence to a Gaussian pseudo random number sequence, the Gaussian pseudo random number sequence including the pseudo random number.

14. The computer readable storage medium of claim 8, wherein the instructions cause the one or more processors to output the output to input memory of a subsequent node.

15. An apparatus to apply a plurality of weights in an artificial intelligence-based model, the apparatus comprising:
at least one memory; and
processor circuitry including one or more of:
at least one of a central processing unit, a graphic processing unit or a digital signal processor, the at least one of the central processing unit, the graphic processing unit or the digital signal processor having control circuitry to control data movement within the processor circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or Application Specific Integrate Circuitry including logic gate circuitry to perform one or more third operations;
the processor circuitry to at least one of perform at least one of the first operations, the second operations or the third operations to:
generate (a) a first element by applying a mean value to an activation and (b) a second element by applying a variance value to a square of the activation, the mean value and the variance value corresponding to a single probability distribution;
generate a pseudo random number; and
generate an output based on the pseudo random number, the first element, and the second element, wherein the output corresponds to the single probability distribution; and
output memory to store the output.

16. The apparatus of claim 15, wherein the processor circuitry is to:
generate the first element by multiplying the mean value with the activation; and
generate the second element by multiplying the variance value with the square of the activation.

17. The apparatus of claim 15, wherein the processor circuitry is to generate the output by:
generating a product by multiplying the second element by the pseudo random number; and
adding the first element by the product.

18. The apparatus of claim 15, wherein the processor circuitry is to:
generate a plurality pseudo random numbers, the plurality of pseudo random numbers including the pseudo random number;
generate a plurality of outputs;
average the plurality of outputs; and
generate the output based on the average.

19. The apparatus of claim 15, wherein the processor circuitry is to generate a plurality of outputs for a plurality of nodes, the plurality of nodes including the node.

20. The apparatus of claim 15, wherein processor circuitry is to generate the pseudo random number by:
generating a pseudo random sequence using shift registers;
adjust the pseudo random sequence by performing an exclusive OR (XOR) function to the pseudo random sequence; and
convert the adjusted pseudo random sequence to a Gaussian pseudo random number sequence, the Gaussian pseudo random number sequence including the pseudo random number.

21. The apparatus of claim 15, wherein processor circuitry is to output the output to input memory of a subsequent node.
